(19) United States
(12) Patent Application Publication
(10) Pub. No.: US 2008/0035545 A1
(43) Pub. Date: Feb. 14, 2008

(54) System for evaporation of rainwater and wastewater proventing waterlogging of land

(76) Inventor: Alfred Aumis, Robert (FR)

Correspondence Address: MILES & STOCKBRIDGE PC, 1751 PINNACLE DRIVE, SUITE 500, MCLEAN, VA, 22102-3833, US

(21) Appl. No.: 11/834,937

(22) Filed: Aug. 7, 2007

(30) Foreign Application Priority Data
Aug. 8, 2006 (FR) 06 07269

(51) Int. Cl. C02F 1/04

(52) U.S. Cl. 210/170.08; 159/29

(57) ABSTRACT

The present invention relates to an evaporation system for rainwater and wastewater designed to reduce or eliminate the storage of water by ground in a parcel of land, comprising a tank made of concrete armour (10), means (16, 17) for supplying the tank (10) with rainwater and wastewater, a source of electric power (15), evaporation means (11) for water in the tank (10) fed electrically by the power source (15), and evacuation means of the steam generated in the tank (10), characterised in that the evaporation means (11) comprise V-shaped rods placed at the bottom of the tank (10) and including a plurality of heating pellets, the evacuation means of the steam including a motorised fan (13) and a conduit of chimney type.

The present invention relates to the field of devices for recovering rainwater and wastewater and more particularly the field of devices for recovering and eliminating rainwater and wastewater.

Currently, it is known to recover wastewater in ditches or basins adapted for their treatment or cleaning. However, elimination of this water can prove complex, especially when the ground has reached the limits of its absorption capacities.

The object of the present invention is to eliminate one or more disadvantages of the prior art and especially to propose a solution for eliminating and preventing the disadvantages which causes the filling of septic ditches and/or ditches for recovery of wastewater and/or rainwater by allowing recycling of at least part of these different wastewaters.

This objective is attained due to a rainwater and wastewater evaporation system designed to reduce or eliminate the storing of water by ground in a parcel of land, comprising a tank with a concrete armour, means for supplying the tank with rainwater and wastewater, a source of electric power, evaporation means for water in the tank fed electrically by the power source, and evacuation means of the steam generated in the tank, characterised in that the evaporation means comprise V-shaped rods placed at the bottom of the tank and including a plurality of heating pellets, the evacuation means of the steam including a motorised fan and a conduit of chimney type.

According to a variant of the invention, the evaporation system comprises an activator device sensitive to a fluid pressure of manocontact type for controlling cutting of the feed from the evaporation means.

According to another variant of the invention, the source of electric power of the evaporation system comprises an electric housing fitted with a circuit breaker and the tank is equipped with a pressure detector thermostat coupled to the activator device for controlling heating of the pellets.

According to another variant of the invention, the evaporation system comprises a conduit of chimney type linked to recovery means of the evaporated water.

According to another variant of the invention, the evaporation system comprises at least one cover for covering the tank.

According to another variant of the invention, the evaporation system comprises measuring and alert filling apparatus for the recovery tank.

A particular application of the measuring and alert filling apparatus of the evaporation system employs:

a wastewater recovery tank,

surveillance means connected to the recovery tank and including a receiver for detecting a threshold filling level,

a central casing fitted with electronic instrumentation for receiving information from the receiver, and

communications means for sending an alert, triggered when the receiver detects that the threshold level has been reached.

According to a particular feature of the invention, detection by the measuring and alert filling apparatus triggers the use of surveillance means of the evaporation system which comprise at least one ultrasound receiver connected to an ultrasound transmitter.

According to another particular feature of the invention, the source of electric power of the evaporation system supplies the electrical feed of at least the motorised fan and an ultrasound transmitter of the surveillance means, a stop button of the evaporation means being provided in the central casing.

According to another particular feature of the invention, the central casing of the evaporation system includes an electronic viewmeter to provide information on the filling height of the recovery tank.

The invention, with its characteristics and advantages, will emerge more clearly from the description made in reference to the attached diagram, in which:

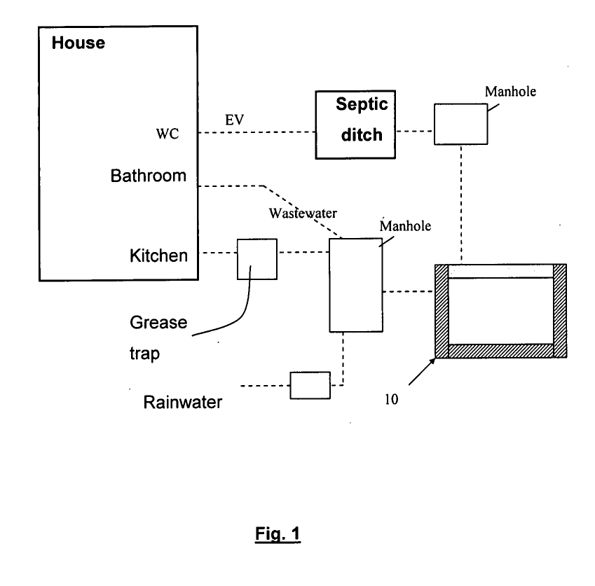

FIG. 1 illustrates an example of positioning of the recovery elements of the wastewater in an installation;

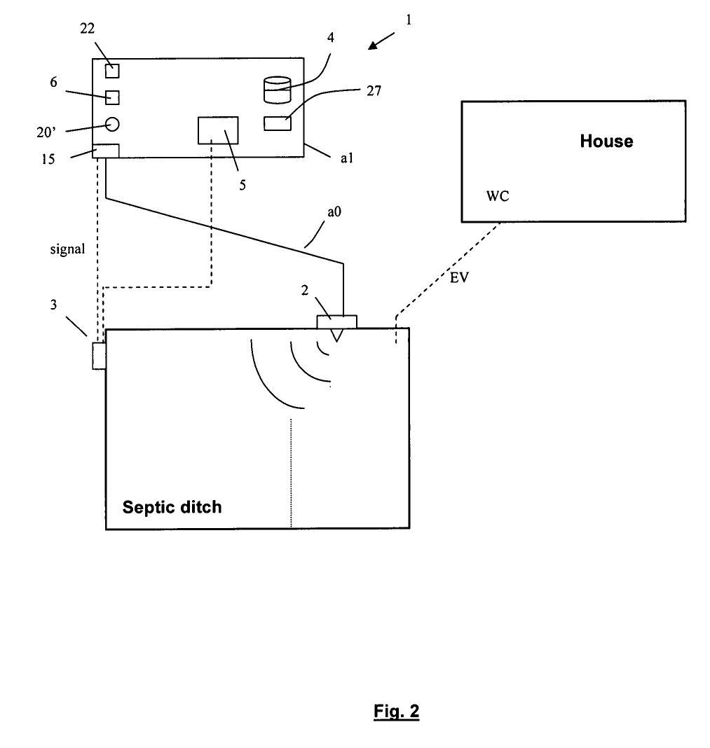

FIG. 2 illustrates an example of positioning of measuring and alert filling apparatus of a septic ditch or wastewater or rainwater recovery ditch;

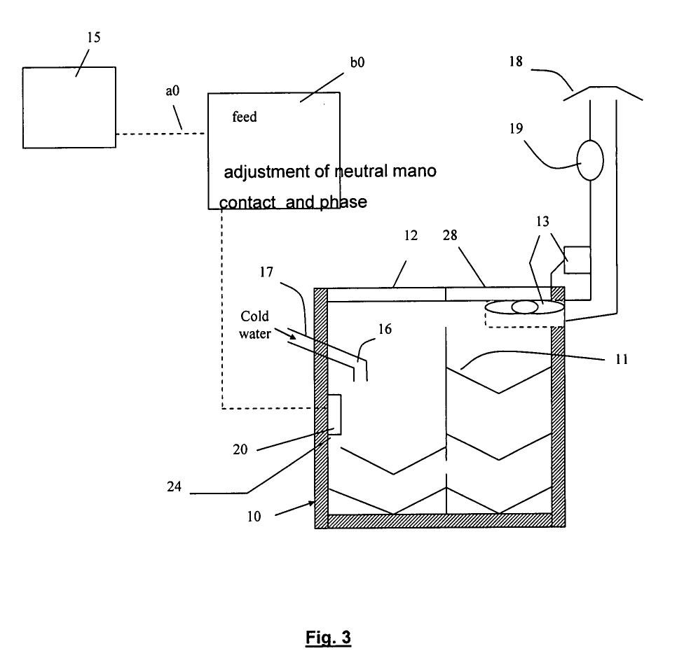

FIG. 3 illustrates the armour and the composition of the tank of the evaporator which is independent and which contains 2 bays.

The system of the present invention is known as RAFM (R: rotation, A: alerter, FM: evaporator of fossil steam). This system can be put in place on any installation comprising a septic ditch or a tank (10) for recovery of wastewater. It should be noted that in the following description, the utilisation of the terms <<ditch>> or <<tank>> make reference to storage means which enable collection and recovery of wastewater or rainwater.

The system according to the invention thus comprises a tank (10), preferably sheathed in concrete armour B22. In the interests of gaining space and reducing bulk, the tank (10) has a vertically placed volume which allows it to be put in place at the level of parcels with restricted surface. The tank (10) is thus fed by rainwater and/or wastewater by at least one supply means (17) connected to evacuation system for bathrooms, kitchens or toilets, this supply system (17) terminating in the upper part of the recovery tank (10). Access to recovery ditches for wastewater for a user can be made at the level of considerations designed and arranged to allow optimal maintenance of the installation.

According to a variant embodiment, the system according to the invention can also be adapted at the level of riverbanks and participate in the elimination of excess water originating from the overflow of rivers to prevent the risk of flooding.

Associated with these recovery means (10) is a source of electric power (15) which can, for example, be formed by an electric current generator. This source of electric power (15) supplies power to one or more rods (11) placed on the walls and in the bottom of the tank (10), these rods (11) being linked to a plurality of heating pellets. These heating elements which are the rods (11) and the pellets are thus positioned in contact with the wastewater stored in the recovery tank (10) or in the septic ditch and enable evaporation of stored water.

According to a variant embodiment the system comprises solar sensors which make the stored water evaporate from the recovered solar power.

Evacuation of water placed in evaporation in the tank (10) employs a fan (13) placed in an orifice of the upper part of the recovery tank (10) and preferably at the level of the ceiling of the tank (10) or even a cover (12, 28) of the tank (10). This fan (13) enables evacuation of steam to a conduit which forms a chimney, the outer evacuation orifice capped by a protective cover (18) to limit infiltration by water. The elimination and the evacuation of wastewater thus enable rotation of the water stored in the recovery tank (10).

According to a variant embodiment, the conduit of chimney type is connected to means (19) for recovery and recycling of the evaporated water. In connecting, for example, the evacuation means of steam from wastewater to a heating system by radiator or by heat exchanger, the recycled water can be utilised for participating in heating of dwellings in a non-limiting way.

According to a particular embodiment of the tank (10), the latter has a volume with a height of 1.710 m, a width of 1.605 m, and a length of 2.010 m for a capacity of around 3000 litres. The surface occupied by the evaporator can then be less than 8 m².

Activation of evaporation engages at least one measuring and alert filling apparatus of the recovery tank (10). This apparatus thus comprises surveillance means (2, 3) connected to the tank (10) which form a detector for filling level. These surveillance means (2, 3) are connected to a central casing (1) which analyses the information transmitted by the surveillance means (2, 3) to optionally trigger an emptying alert of the tank (10) or of the evaporation system of the invention when a threshold value (4), recorded in a memory of the central casing, is reached by the filling tank.

According to a particular embodiment, the emptying alert can be transmitted by an automated device on a purification service via adapted communications means, for example by telephone or Internet, with the purification organism.

According to a particular embodiment, the alert device integrates a transformer.

According to a preferred embodiment, the information transmitted by the surveillance means (2, 3) allow the central casing (1) to view the filling level of the tank (10) due to an electronic viewing device of viewmeter type.

According to a particular embodiment, the surveillance means (2, 3) are formed by ultrasound transmitters and receivers positioned in the upper part, inside the tank (10). According to a preferred embodiment, this apparatus has dimensions of the order of 23 cm by 20 cm which are highly reduced to limit its bulk in the tank.

According to a preferred embodiment, the surveillance means (2, 3) and the fan (13) are fed by electricity from a source of electric power (15) common to the rods (11) and the heating pellets.

To permit rapid arrest of evaporation by the user, the central casing (1) comprises a stop button (22) of the evaporation means. Similarly, the device for supply and activation of the evaporation means (11) formed by the rods and the heating pellets is connected to a cutting device sensitive to fluid pressure of manocontact type, this device capable of intervening when the pressure of the liquid in the tank becomes too great relative to the evacuation capacities of the ventilation means (13). Therefore, the tank (10) is equipped with a pressure detector thermostat (20) coupled to the activator device which controls the starting of the heating of the heating pellets. This detector (20) is positioned against one of the inner walls of the tank (10), protected by a grid (24) and connected to the supply housing (15) of the evaporation means (11). The reconnaissance of the clearance of threshold pressure and/or temperature values by the detection device (20) causes triggering or stopping of the evaporation means (11) and/or evacuation means of the evaporated water.

The electric supply housing (15) may also integrate a circuit breaker.

So as to reduce any risk of short-circuit, the set of attachment and connection means (a0) between the different electric (15) and/or electronic (1) elements of the installation are sealed tight.

1. An evaporation system for rainwater and wastewater designed to reduce or eliminate the storage of water by ground in a parcel of land, comprising a concrete tank (10), means for supplying (16, 17) the tank (10) with rainwater and wastewater, a source of electric power (15), means for evaporation (11) of water in the tank (10), said evaporation means being connected to the power source (15), and means for evacuation of steam generated in the tank (10), characterised in that the means for evaporation (11) comprise V-shaped rods placed at the bottom of the tank (10) and including a plurality of heating pellets, the means for evacuation including a motorised fan (13) and a conduit of chimney type.

2. The system as claimed in claim 1, characterised in that the system comprises an activator device sensitive to fluid pressure of manocontact type for controlling the power to the means for evaporation (11).

3. The system as claimed in claim 2, characterised in that the source of electric power (15) comprises an electric housing for a circuit breaker and in that the tank (10) includes a pressure detector thermostat (20) coupled to an activator device for controlling heating of the pellets.

4. The system as claimed in claim 1, characterised in that the conduit of chimney type is connected to means for recovery (19) of evaporated water.

5. The system as claimed in claim 1, characterised in that the system comprises at least one cover (12, 28) for the tank (10).

6. The system as claimed in claim 1, characterised in that the system comprises measuring and alert filling apparatus for a septic ditch.

7. The system as claimed in claim 6, characterised in that application of the measuring and alert filling apparatus of the evaporation system engages:
a wastewater recovery tank (10),
surveillance means (2, 3) connected to the recovery tank (10) and including a receiver (3) for detecting a threshold filling level,
a central casing (1) fitted with electronic instrumentation for receiving information from the receiver (3), and
communications means for sending an alert, triggered when the receiver (3) detects that the threshold level (4) has been reached.

8. The system as claimed in claim 6, characterised in that detection by the measuring and alert filling apparatus triggers the employment of surveillance means (2, 3) of the system which comprise at least one ultrasound receiver (3) connected to an ultrasound transmitter (2).

9. The system as claimed in claim 7, characterised in that the source of electric power (15) is connected to supply electric power to at least a motorised fan (13) and an ultrasound transmitter (2) of the surveillance means (2, 3), and a stop button (22) of the evaporation means (11) being provided in a central casing (1).

10. The system as claimed in claim 7, characterised in that a central casing (1) includes an electronic viewmeter for providing information on the filling height of the recovery tank (10).

11. The system of claim 7 characterized in that the source of electric power (15) is connected to supply electric power to at least the motorised fan (13) and the ultrasound transmitter (2) of the surveillance means (2, 3), a stop button (22) of the evaporation means (11) being provided in a central casing (1).

12. The system of claim 7 characterized in that the central casing (1) includes an electronic viewmeter for providing information on the filling height of the recovery tank (10).

13. The system of claim 7 characterized in that detection by the measuring and alert filling apparatus triggers the employment of surveillance means (2, 3) of the system which comprise at least one ultrasound receiver (3) connected to an ultrasound transmitter (2).

14. The system as claimed in claim 8, characterised in that detection by the measuring and alert filling apparatus triggers the employment of surveillance means (2, 3) of the system which comprise at least one ultrasound receiver (3) connected to an ultrasound transmitter (2).

15. The system as claimed in claim 8, characterized in that a central casing (1) includes an electronic viewmeter for providing information and the filling height of the recovery tank.

16. The system of claim 9, characterized in that a central casing (1) includes an electronic viewmeter for providing information on the filling height of the recovery tank.

17. The system of claim 2, characterized in that the conduit of chimney type is connected to means for recovery (19) of evaporated water.

18. The system of claim 3, characterized in that the conduit of chimney type is connected to means for recovery (19) of evaporated water.
